(19) United States
(12) Patent Application Publication
(10) Pub. No.: US 2004/0162108 A1
(43) Pub. Date: Aug. 19, 2004

(54) Communication adapter and method

(76) Inventors: Rongyao Fu, Beijing (CN); Song Song, Beijing (CN)

Correspondence Address: Rafeal A Perez-Pineiro, IBM Corporation, Intellectual Property Law Department, P O Box 218, Yorktown Heights, NY, 10598, US

(21) Appl. No.: 10/473,636

(22) PCT Filed: Mar. 8, 2002
(86) PCT No.: PCT/GB02/01077

(30) Foreign Application Priority Data
Mar. 28, 2001 (CN) 01111790.7

(51) Int. Cl. H04B 1/38; H04M 1/00

(52) U.S. Cl. 455/557; 455/1

(57) ABSTRACT

A Bluetooth adapter used for infrared interfaces, characterized in comprising: a Bluetooth interface for exchanging data streams with the Bluetooth device via Radio Frequency links; a protocol converting unit for modulating the data streams coming from the Bluetooth device into electronic signals complying with the infrared standards and demodulating the electronic signals sent to the Bluetooth device into data streams; a means for exchanging electronic signals with the infrared device; and a microprocessor for controlling various components of said Bluetooth adapter to enable then to perform their own functions.

The invention relates to Bluetooth Communication technology, in particular to an apparatus and a method for data communication using Bluetooth technology.

Nowadays, many electric appliances on the market are equipped with infrared receivers so that the users are able to control the electric appliances such as TV sets and video recorders by using infrared remote controllers. The infrared communication employed in the electric appliances is a kind of direct infrared communication, i.e. point-to-point communication.

In addition, in prior art there is a Bluetooth technology. Bluetooth is a wireless technological standard provided by Ericsson Co., IBM Co., Intel Co., Nokia Co. and Toshiba Co., as initiators, in May 1998. Just two years from then on, more than 1800 companies have joined the Special Interest Group (SIG) of Bluetooth technology.

Specifically, Bluetooth technology is a short-distance wireless communication (radio frequency) technology working on the ISM (Industry-Science-Medicine) band of 2.4 GHz. Short-distance means that the effective communication distance between Bluetooth devices is about 10-100 meters, i.e. the effective distance is 10 meters at the minimum transmission power of 1 mW (0 dBm), while the effective distance is 100 meters at the maximum transmission power of 100 mW (20 dBm). The basic network structure of Bluetooth is a piconet consisting of a master device and up to 7 slave devices, while some piconets may constitute a scatternet of larger scale. Bluetooth uses time division multiple access (TDMA) and can support at least 1 asynchronous data communication path and up to 3 synchronous communication paths. Therefore, it is possible to use Bluetooth technology to interconnect various devices wirelessly at low expense to establish wireless channels between the devices for voice communication and data communication.

Compared with the direct infrared technology, Bluetooth technology has the following advantages:

(1) 360 degrees of orientation, i.e. not necessary to be seen directly;

(2) relatively long distance, ranging from 10 to 100 meters;

(3) the communication signals can pass through walls;

(4) supporting point-to-multipoint interconnection;

(5) not influenced by the background light (e.g. sun light).

Accordingly, the present invention provides An adapter used for communication between an RF device and an infrared device, comprising: an interface for communication with the RF device; a protocol conversion unit for modulating communication signals from the RF device into communication signals complying with infrared standards; a means for communication with the infrared device; a microprocessor for controlling said interface, protocol conversion unit, and means for communication.

Moreover, the invention further provides a method of communication between an Bluetooth device and an infrared device comprising the step: responsive to receiving a communication signal from the Bluetooth: modulating the received communication signal into a communication signal complying with the infrared standards; and communicating the communication signal complying with the infrared standards to the infrared device.

Preferably, the signal received from the RF device includes codes for remote controlling the infrared device.

Preferably, the adapter also enables communication from the infrared device to the RF device.

Preferably, the RF device is a Bluetooth device and the RF communication means is a Bluetooth interface.

The adapter of the invention is cheap, but can greatly increase the flexibility of application of the conventional infrared devices. For example, it is possible to connect the adapter of the invention to the infrared interface of the electric appliances to enable conversion between the Bluetooth communication protocol and the infrared communication protocol. Hence, the conventional infrared devices with infrared interfaces (e.g. electric appliances) can interact with other devices having Bluetooth communication ability, so that they can share the merits of Bluetooth technology without modifying the infrared devices.

The invention will now be described, by way of example only, with reference to a preferred embodiment thereof, as illustrated in the accompanying drawings in which:

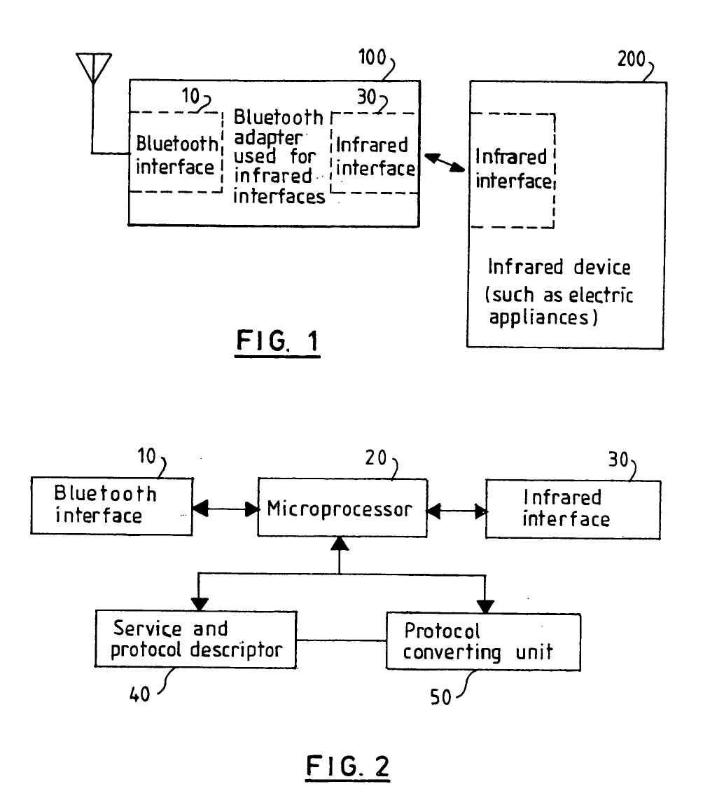

FIG. 1 schematically shows the connection relationship between the Bluetooth adapter used for infrared interfaces according to the preferred embodiment of the present invention and the infrared device;

FIG. 2 schematically shows the logical structure of the Bluetooth adapter used for infrared interfaces according to the preferred embodiment of the present invention;

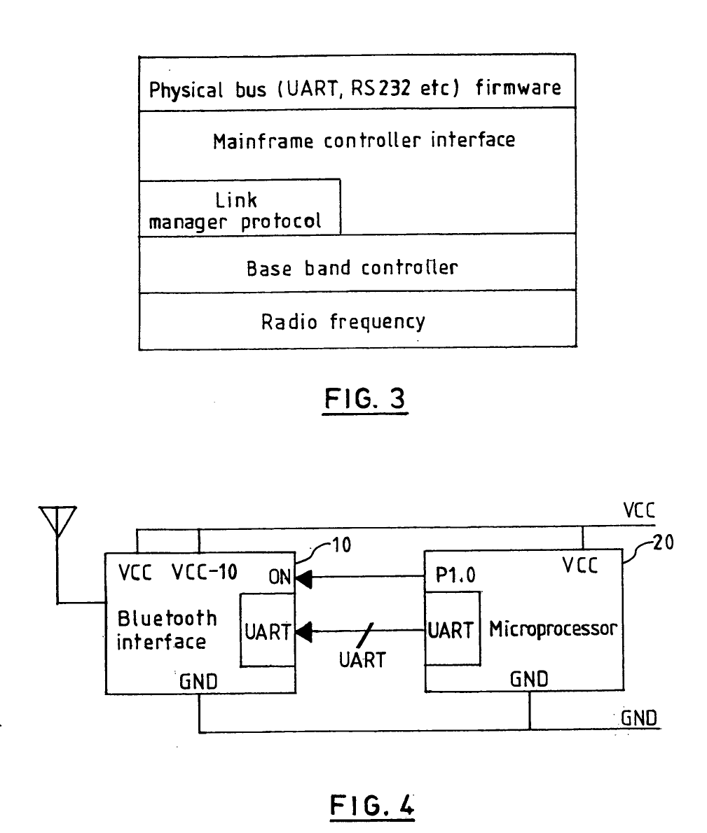

FIG. 3 schematically shows the relationship between the internal constituents of the Bluetooth interface of FIG. 2;

FIG. 4 is a connection schema between the Bluetooth interface of FIG. 2 and the microprocessor;

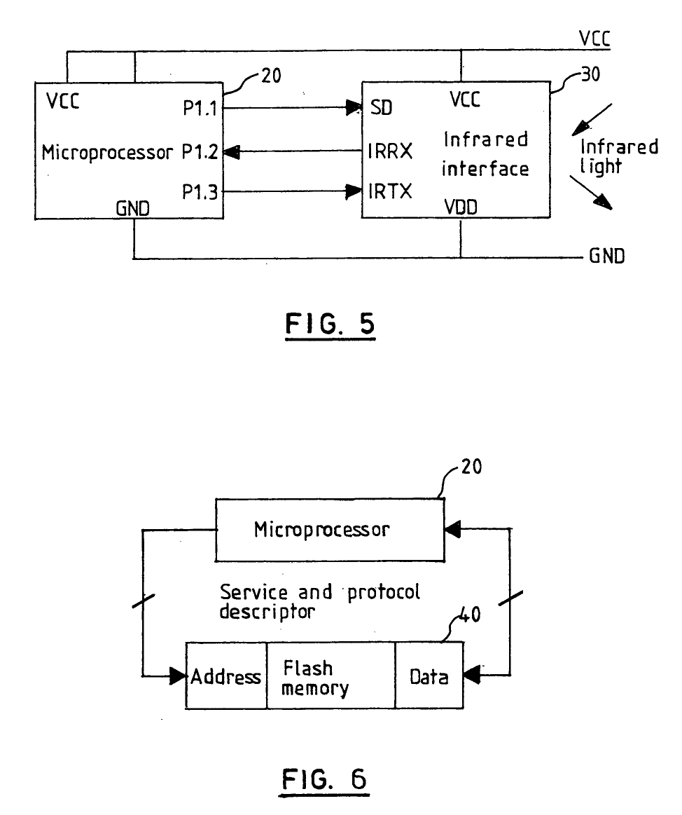

FIG. 5 is a connection schema between the infrared interface of FIG. 2 and the microprocessor;

FIG. 6 is an implementation schema of the service and protocol descriptor of FIG. 2;

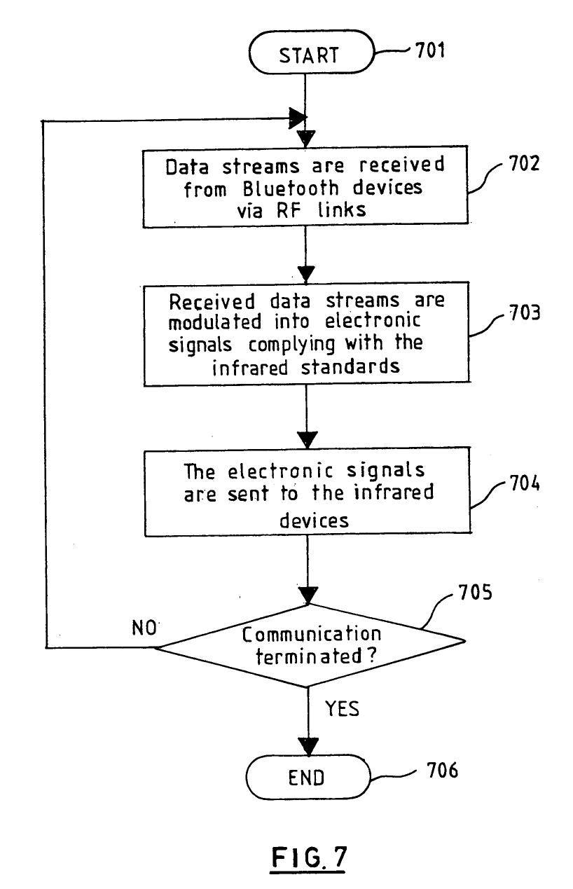

FIG. 7 is a flow chart of the method of data communication between the Bluetooth device and the infrared device according to the preferred embodiment of the present invention.

FIG. 1 schematically shows the connection relationship between the Bluetooth adapter used for infrared interfaces according to the preferred embodiment of the present invention and the infrared device. In FIG. 1, reference number 100 represents a Bluetooth adapter used for infrared interfaces. The adapter has a Bluetooth interface 10 and an infrared interface 30 therein. Reference number 200 represents a conventional infrared device with an infrared interface, such as electric appliances. Infrared interface 30 can communicate with the infrared interface of the infrared device 200 using a conventional infrared communication protocol. Bluetooth interface 10 can communicate with the devices capable of Bluetooth communication using a conventional Bluetooth communication protocol. In addition to the Bluetooth interface 10 and the infrared interface 30, Bluetooth adapter 100 further has a means for protocol conversion between the Bluetooth communication protocol and the infrared communication protocol.

FIG. 2 schematically shows the logical structure of Bluetooth adapter used for infrared interfaces according to the preferred embodiment of the present invention. In FIG. 2, reference number 10 represents a Bluetooth interface, reference number 20 represents a microprocessor, reference number 30 represents an infrared interface, reference number 40 represents a service and protocol descriptor, and reference number 50 represents a protocol converting unit.

Bluetooth interface 10 is used for implementing the Bluetooth hardware and Bluetooth firmware specified in the Bluetooth specifications. Bluetooth hardware includes an analog part-Bluetooth radio transceiving means and a digital part-link controller. The link controller executes base-band protocol and other low level link routines. The Bluetooth firmware includes a link manager for providing the ability to create and control links, and a mainframe controller interface for providing a unified accessing method of the Bluetooth base-band controller and the link manager. In addition, in the Bluetooth interface 10, there may be a physical bus firmware between the mainframe system and the mainframe controller interface firmware. FIG. 3 schematically shows the relationship between the internal constituents of the Bluetooth interface 10.

With Bluetooth interface 10, the mainframe system (such as microprocessor 20 in FIG. 2) can use any standard hardware interface, such as UART, RS232, USB etc. so as to employ unified command interfaces to access the Bluetooth hardware and firmware functions. Later the connection between Bluetooth interface 10 and microprocessor 20 will be exemplified and described with reference to FIG. 4.

Infrared interface 30 is used for converting the electronic signals received from microprocessor 20 into infrared signals, i.e. infrared pulses, and sending them out, and for converting infrared signals received from other devices with infrared transmission ability into electronic signals acceptable by the microprocessor. Infrared interface 30 includes an infrared transceiver and some separate electronic components. The connection schema between infrared interface 30 and microprocessor 20 will be described later with reference to FIG. 5.

Service and protocol descriptor 40 is used for storing the service records related to Bluetooth adapter 100, wherein the service records describe the service features related to the adapter. The Bluetooth system provides a mechanism for discovering the services. In other words, the devices having Bluetooth functions are able to discover services available on another device having Bluetooth functions and determine the features of those available services. According to the service discovering protocol defined in the Bluetooth specifications, the Bluetooth adapter keeps a service record list. In the embodiment shown in FIG. 2, the service records related to Bluetooth adapter 100 are stored in service and protocol descriptor 40.

Now take an ordinary infrared controlled device (such as a TV set, a video recorder etc) for example to further explain the function of service and protocol descriptor 40. A user can operate the infrared controlled device with an appropriate conventional infrared remote controller. The descriptive information of the conventional infrared remote controller, such as the number of buttons, brief description of buttons, the internal code of each button etc., is stored in the service and protocol descriptor 40 of the Bluetooth adapter. In such a way, a Bluetooth device, used as a virtual remote controller, can obtain the descriptive information about the conventional infrared remote controller from the Bluetooth adapter 100 and draw the panel of a conventional infrared remote controller on the screen of the Bluetooth device (i.e. the virtual remote controller) based on those descriptive information. The users can click the button on the panel. Once a user clicks a button on the panel, the Bluetooth device (i.e. the virtual remote controller) sends a corresponding code to the Bluetooth adapter for further processing. Thus, by storing descriptive information relating to one or more conventional infrared remote controllers, the Bluetooth adapter can be used as an agent of conventional infrared remote controllers.

In addition to the descriptive information relating to one or more infrared remote controllers, the service and protocol descriptor 40 should further store other information related to the internal usage, such as description about infrared standards employed by the associated controlled devices. The information related to infrared standards includes function (button) code, prefix, suffix, start and end sequences, one and zero code and so on.

Later an implementation schema of the service and protocol descriptor 40 will be described with reference to FIG. 6.

Protocol converting unit 50 is used to convert the function code/command received from other Bluetooth devices into corresponding electronic signals. Then the electronic signals are converted by the infrared interface 30 into infrared pulses. Hence, protocol converting unit 50 can implement some of the software protocol stacks defined in the Bluetooth Specifications, such as service discovering protocol (SDP), which enables the service descriptions stored in the adapter to be discovered and retrieved by other Bluetooth devices. In addition, protocol converting unit 50 can implement infrared protocol for modulating data streams into electronic signals, or demodulating the electronic signals into data streams.

Protocol converting unit 50 can be implemented with software stored in non-volatile memories such as flash memories and read-only memories. One of the implementation schema of protocol converting unit 50 is similar to the implementation schema of the service and protocol descriptor of FIG. 6.

Microprocessor 20 controls the above-mentioned components, enabling them to perform their own tasks.

Although there is an infrared interface 30 in the Bluetooth adapter 100 shown in FIG. 1 and FIG. 2, its apparent to those skilled in the art that the relevant signal lines of the microprocessor 20 can be connected directly to the signal lines of the microprocessor in the controlled device, thereby sending the electronic signals output by the microprocessor 20 directly to the controlled device. In such a way, the infrared interface 30 in Bluetooth adapter 100 can be omitted.

Now the connection between Bluetooth interface 10 and microprocessor 20 in FIG. 2 will be described with reference to FIG. 4. As shown in FIG. 4, Bluetooth interface 10 employs a standard UART physical bus to interact with microprocessor 20. Microprocessor 20 employs an I/O port to enable or disable the operations of Bluetooth interface 10. Standard four-wire UART port is used here for sending commands to or receiving data/events from the Bluetooth interface 10. The formats of the commands/data/event packets are defined in the mainframe controller interface function definitions in the Bluetooth specifications.

Below the connection between infrared interface 30 and microprocessor 20 in FIG. 2 will be described with reference to FIG. 5. As shown in FIG. 5, infrared interface 30 has a shut down (SD) input signal port for enabling/disabling the operation of the entire infrared interface 30. Infrared interface 30 further has an IRTX input signal port for receiving electronic signals from microprocessor 20. Infrared interface 30 further has an IRRX output signal port for sending electronic signals to microprocessor 20.

Below an implementation schema of service and protocol descriptor 40 will be described with reference to FIG. 6. As shown in FIG. 6, service and protocol descriptor 40 can be implemented with a flash memory, in which various information that the service and protocol descriptor 40 should store are stored. Of course, service and protocol descriptor 40 can also be implemented with other non-volatile memories (such as read only memories).

As stated before, protocol converting unit 50 can also be implemented with non-volatile memories. The configuration thereof is similar to that of FIG. 6 and will not be described further.

FIG. 7 is a flow chart of the method of data communication between the Bluetooth adapter of the preferred embodiment of the present invention and an infrared device. In step 701, data communication starts. In step 702, data streams are received from the Bluetooth device via RF links. In step 703, received data streams are modulated into electronic signals complying with the infrared standards of the infrared device. In step 704 the electronic signals are sent to the infrared device. It should be noted that it is possible to send electronic signals to the signal lines of the microprocessor of the infrared device through direct cable connection. Alternatively, electronic signals can be converted into infrared pulses and these infrared pulses are sent to the infrared device, as in the conventional infrared remote controllers. In step 705, it is judged whether the data communication is to be terminated or not. If the result of judgement is NO, the procedure turns to step 702. If the result of the judgement is YES, the procedure proceeds to step 706. In step 706 the procedure terminates.

FIG. 7 only describes the procedure of transferring data to the infrared device from the Bluetooth device. For those skilled in the art, however, the procedure of transferring data to the Bluetooth device from the infrared device is just the inverse of the procedure shown in FIG. 7, that is: receiving infrared pulses from the infrared device or receiving electronic signals directly from the microprocessor of the infrared device; modulating the electronic signals into data streams; and transmitting the data streams to the Bluetooth device through RF links.

The Bluetooth adapter and data communication method of the invention can be used for various purposes. One of the convenient application is to construct a Bluetooth adapter for the remote control of the conventional infrared controlled devices (such as TV sets and video recorders).

The descriptive information about the remote controllers of a plurality of controlled devices and the descriptive information about the infrared standards employed by a plurality of controlled devices are loaded into the flash memory of the Bluetooth adapter in advance. The flash memory together with the microprocessor constitute the service and protocol descriptor 40 shown in FIG. 2.

During remote control operation, the infrared port of the Bluetooth adapter is configured opposite to the infrared port of the controlled devices, or those two infrared ports are mounted together, to ensure that each infrared port is within the working range of the other.

The Bluetooth adapter for operating the infrared device is able to recognize the existence of a Bluetooth device once it is in the RF range of a Bluetooth device. Then the descriptive information about the remote controller stored in the flash memory of the Bluetooth adapter is sent to the Bluetooth adapter by using the service discovering protocol of the Bluetooth system. Afterwards, the Bluetooth device draws a remote controller on its display screen based on the above-mentioned descriptive information about the remote controller. Hence the users are able to operate the infrared device via the Bluetooth device.

Once a user clicks a button on the display screen, the button code of the button will be sent to the Bluetooth adapter through Bluetooth data links. Then the Bluetooth adapter converts the internally used button code into a function (button) code complying with the infrared standards. Next, the Bluetooth adapter calls an infrared protocol implementation routine to modulate the function code into electronic signals. Those electronic signals include start sequence, prefix, function code, suffix and end sequence. Finally, these electronic signals are converted into corresponding infrared pulses by the infrared interface. According to the conventional way, the infrared pulses enable the controlled device to execute the corresponding operations.

Though the preferred embodiments of the invention have been shown and described in details, it is to be recognized that various changes and modifications can be made without departing from the scope of the claims.

1. An adapter used for communication between an RF device and an infrared device, comprising:
an interface for communication with the RF device;
a protocol conversion unit for modulating communication signals from the RF device into communication signals complying with infrared standards;
a means for communication with the infrared device;
a microprocessor for controlling said interface, protocol conversion unit, and means for communication.

2. An adapter according to claim 1 wherein the means for communication with the infrared device comprises:
means for converting the communication signals complying with infrared standards from the protocol converting unit into infrared pulses and sending the infrared pulses to the infrared device.

3. An adapter according to claim 1 wherein the means for communication with the infrared device comprises at least one line connected to the signal line in the infrared device.

4. An adapter according to claim 2 or claim 3 wherein:
the means for communication with the infrared device further comprises means for receiving infrared pulses from the infrared device and converting them into communication signals complying with infrared standards; and
the protocol conversion unit further demodulates communication signals complying with infrared standards into communication signals complying with the RF device.

5. The adapter according to any preceding claim further comprising:
a service descriptor for storing at least one service record describing various services provided to said adapter.

6. The adapter according to any preceding claim further comprising:
a protocol descriptor for storing information related to the infrared standards employed by at least one infrared device.

7. The adapter according to any preceding claim wherein the RF device is a Bluetooth device.

8. A method of communication between an Bluetooth device and an infrared device comprising the steps:
responsive to receiving a communication signal from the Bluetooth device:
modulating the received communication signal into a communication signal complying with the infrared standards; and
communicating the communication signal complying with the infrared standards to the infrared device.

9. A method according to claim 8, wherein the step of communicating with the infrared device comprises the steps of:
converting the communication signal complying with the infrared standards into infrared pulses; and
sending the infrared pulses to the infrared device.

10. A method according to claim 8 or 9 further comprising the step of:
responsive to receiving infrared pulses from the infrared device:
converting the infrared pulses into a second communication signal complying with infrared standards; and
demodulating the second communication signal complying with infrared standards into communication signals complying with the Bluetooth device.
